(19) United States
(12) Patent Application Publication
(10) Pub. No.: US 2023/0272283 A1
(43) Pub. Date: Aug. 31, 2023

(54) PHOSPHORUS-CONTAINING FLAME RETARDANT MIXTURES, A PROCESS FOR PRODUCTION OF SAID MIXTURES AND USE OF SAID MIXTURES, AND ALSO EPOXY RESIN FORMULATIONS WHICH COMPRISE SAID FLAME RETARDANT MIXTURES

(71) Applicant: CLARIANT INTERNATIONAL LTD, Muttenz (CH)

(72) Inventors: Frank OSTEROD, Erftstadt (DE); Martin SICKEN, Köln (DE); Harald BAUER, Kerpen (DE); Oliver HAUENSTEIN, Bonn (DE)

(73) Assignee: CLARIANT INTERNATIONAL LTD, Muttenz (CH)

(21) Appl. No.: 18/008,058

(22) PCT Filed: Jun. 11, 2021
(86) PCT No.: PCT/EP2021/065804

§ 371 Date: Dec. 2, 2022

(30) Foreign Application Priority Data
Jun. 17, 2020 (EP) 20180542.1

(51) Int. Cl. C09K 21/14; C09K 21/12; C08G 59/14; C07F 9/655

(52) U.S. Cl. CPC C09K 21/14; C09K 21/12; C08G 59/1488; C07F 9/65502

(57) ABSTRACT

Phosphorus-containing flame retardant mixtures, a process for production of said mixtures and use of said mixtures, and also epoxy resin formulations which comprise said flame retardant mixtures. The present invention relates to phosphorus-containing flame retardant mixtures, comprising individual flame retardants having in each case one or more functional groups of the formulae (I), (II) and (III), where, based on the total quantity of functional groups in the flame retardant mixture, 1 to 98 mol % of functional groups of the formula (I), 1 to 35 mol % of functional groups of the formula (II) and 1 to 98 mol % of functional groups of the formula (III) are present, and where R¹ and R² are identical or different and are mutually independently hydrogen, C₁- to C₁₂-alkyl, linear or branched, and/or C₆- to C₁₈-aryl and the entirety of (I), (II) and (III) is always 100 mol %.

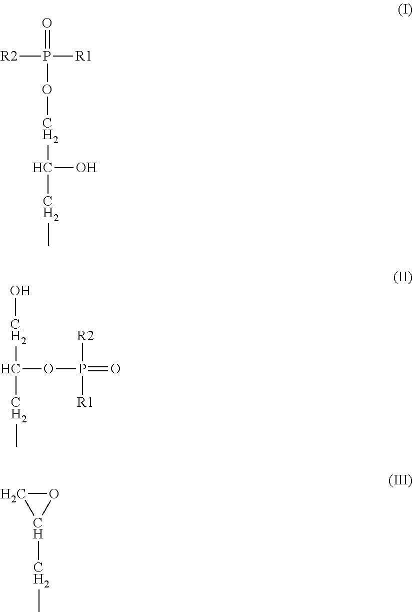

Composite materials that are widely used in order to save weight and take the form of composite components in the transport sector (rail, air, ship, road, etc.) are subject to strict fire-protection requirements intended to ensure the safety of the users or passengers.

Strict limiting values for behaviour in relation to fire and smoke, and for smoke toxicity, are stipulated in particular in the European standard EN 45545-2 relating to rail transport, and also in FAR 25.853 relating to air travel.

There are various available methods for the manufacture of such composite components. The use of solvents of the type described for example in the electronics sector for the manufacture of prepregs (US-2012/0279769A1) is often not desired or technically not possible.

Such formulations, which can comprise not only the actual resin but also other components such as fillers, flame retardants and hardeners, must therefore have a viscosity that is sufficiently low to provide uniform wetting of the reinforcement material (e.g. glass fibres or carbon fibres in the form of fibres, woven fabrics, laid scrims or knitted fabrics) and to permit manufacture of the corresponding component.

The resin used must therefore have a low initial viscosity and good flow behaviour and wetting behaviour, so that production of the composite components can be technically and economically successful. The flame retardant used must moreover have no adverse effect on processing.

Various resin systems are used for the manufacture of composite components, but many of these do not have sufficiently good behaviour in relation to fire, and it is therefore necessary in such cases to employ appropriate flame retardants in order to permit use, in particular in the transport sector.

Use of solid flame retardants for manufacture of composite components is often impossible because the use of such flame retardants leads to a major increase of viscosity and therefore prevents manufacture of the composite components or requires considerable quantities of solvents, which then in turn require removal.

In the case of the resin transfer moulding (RTM) process, which is a popular method for the production of mouldings, plungers are used to inject the moulding composition from a, mostly heated, upstream chamber by way of distributor channels into the shaping chamber, in which heat and pressure are used to harden the moulding composition.

When the abovementioned formulations are used not only in the RTM process but also in infusion processes, a filtration effect is often observed.

EP-3309190A1 describes a process for the production of epoxy resins with use of substituted phosphinic salts which are added as additive filler. Associated disadvantages are the major viscosity increase during processing and the fact that the filler disadvantageously remains in the final product.

DE-4308187A1 describes the production of phosphorus-modified epoxy resins with use of phosphinic anhydrides in solvent-containing systems which incur high drying costs.

EP-2794623B1 describes the use of dialkylphosphinic acid mixtures via mixing into a polymer system. The epoxy resins thus produced exhibit reduced thermal expansion.

CA-A-2826672 describes the use of phosphorus-modified epoxy resins which comprise two regioisomers. In this case, 9,10-dihydro-9-oxa 10-phosphaphenanthrene-10-oxide (DOPO), where both regioisomers have a P—C bond to the C₂ and C₃ carbon atom of the epoxide reacted, is used for the modification of the epoxy resin.

WO-2017/117383A1 describes the use of fire-protected composite components in the airline sector. The epoxy resins required for this purpose are modified with DOPO or diethylphosphinic acid in the presence of a solvent, and the epoxy resins are liquid or solid and have an epoxy equivalent of 170 to 450 g/mol.

In particular, there is a lack of flame retardants and flame retardant mixtures which, even when used in small quantities, achieve good flame retardancy in the epoxy resin and do not adversely affect the viscosity of the epoxy resin formulation and therefore exhibit good wetting behaviour. There is moreover a lack of filler-free, flame-retardant epoxy resin formulations which are also amenable to solvent-free processing and which, in the final component, have good mechanical and physical properties (e.g. high glass transition temperatures).

This object is achieved according to the invention via phosphorus-containing flame retardant mixtures, comprising individual flame retardants having in each case one or more functional groups of the formulae (I), (II) and (III),

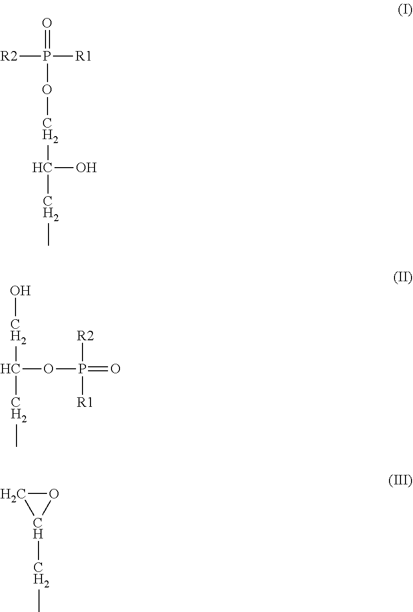

where, based on the total quantity of functional groups in the flame retardant mixture, 1 to 98 mol % of functional groups of the formula (I), 1 to 35 mol % of functional groups of the formula (II) and 1 to 98 mol % of functional groups of the formula (III) are present, and where R¹ and R² are identical or different and are mutually independently hydrogen, C₁- to C₁₂-alkyl, linear or branched, and/or C₆- to C₁₈-aryl and the entirety of (I), (II) and (III) is always 100 mol %.

It is preferable that in the phosphorus-containing flame retardant mixtures R¹ and R² are identical or different and are mutually independently hydrogen, methyl, ethyl, n-propyl, isopropyl, n-butyl, isobutyl, sec-butyl, tert-butyl, n-pentyl, 2-methylbutyl, 3-methylbutyl, 3-methylbut-2-yl, 2-methylbut-2-yl, 2,2-dimethylpropyl, hexyl, heptyl, octyl, nonyl, decyl, cyclopentyl, cyclopentylethyl, cyclohexyl, cyclohexylethyl and/or phenyl.

It is particularly preferable that R¹ and R² are identical or different and are mutually independently methyl, ethyl, n-propyl, isopropyl, n-butyl, isobutyl, sec-butyl and/or tert-butyl.

It is preferable that the phosphorus-containing flame retardant mixtures comprise
5 to 94 mol % of formula (I),
3 to 35 mol % of formula (II) and
3 to 92 mol % of formula (III),
where the entirety of (I), (II) and (III) is always 100 mol %.

It is particularly preferable that the phosphorus-containing flame retardant mixtures comprise
to 90 mol % of formula (I),
to 30 mol % of formula (II) and
to 70 mol % of formula (III),
where the entirety of (I), (II) and (III) is always 100 mol %.

It is preferable that in the mixture of the formulae (I) and (II) the proportion T (in mol %) of formula (II) is calculated from T=[y/(x+y)]*100%, where x is the quantity of formula (I) and y is the quantity of formula (II), in each case in mol %.

It is preferable that T is 10 to 70 mol %.

It is particularly preferable that T is 20 to 45 mol %.

The phosphorus-containing flame retardant mixtures of the invention can also be present in a form such that the individual flame retardants having the functional groups (I), (II) and (III) in the flame retardant mixtures correspond to the formulae R²¹—O-(I), R²¹—O-(II), and/or R²¹—O-(III), where R²¹ means linear or branched alkyl structures having 2 to 8 carbon atoms and/or means polypropylene oxides of the type —[—CH(CH₃)—CH₂—O—]_{K}—H or

—[—CH₂—CH(CH₃)—O—]_{K}—H and/or means polyethylene oxides of the type —[—CH₂—CH₂—O—]_{K}—H, where K is in each case an integer from 1 to 12.

In another embodiment, the individual flame retardants having the functional groups (I), (II) and (III) in the flame retardant mixtures correspond to the formula D-O—[—CH₂—CH₂—O—]ᵣ-E and/or

D-O—[—CH(CH₃)—CH₂—O—]ᵣ-E, where D and E can be identical or different and in each case represent the formula (I), (II) and/or (III), and r is an integer from 1 to 12.

In yet another embodiment, the individual flame retardants having the functional groups (I), (II) and (III) in the flame retardant mixtures correspond to the formula (IV)

E-Q-D (IV),

where Q represents the following formula (V)

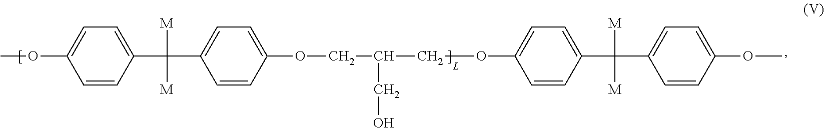

in which M is hydrogen or methyl and where D and E can be identical or different and in each case represent the formulae (I), (II) and/or (III) and L is an integer from 0 to 5.

In another embodiment, the individual flame retardants having the functional groups (I), (II) and (III) in the flame retardant mixtures correspond to the formula (VI)

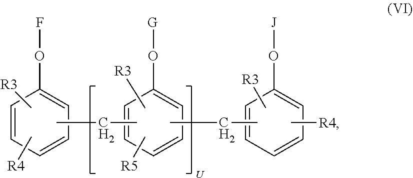

where F, G and J can be identical or different and in each case represent the formulae (I), (II) and/or (III), U is an integer between 1 and 12, R³ is hydrogen, methyl, ethyl, propyl and/or butyl, and R⁴ and R⁵ are mutually independently hydrogen, methyl and/or (VII)

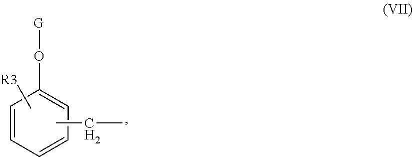

where G and R³ are defined as above.

Finally, the individual flame retardants having the functional groups (I), (II) and (III) in the flame retardant mixtures can correspond to the formula (VIII)

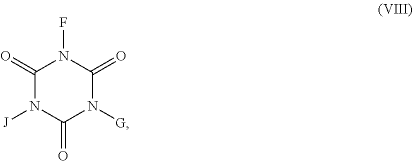

where F, G and J can be identical or different and in each case represent the formulae (I), (II) and/or (III).

The invention also provides phosphorus-containing flame retardant mixtures comprising flame retardants having in each case one or more functional groups of the formulae (I), (II) and (III)

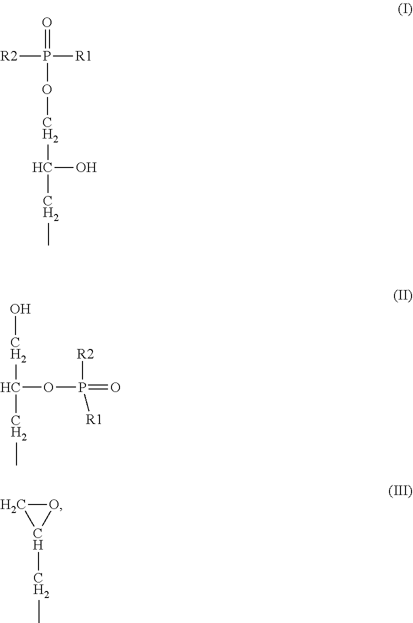

where R¹ and R² are identical or different and are mutually independently hydrogen, C₁- to C₁₂-alkyl, linear or branched, and/or C₆- to C₁₈-aryl, characterized in that the flame retardants were produced by reaction of at least one phosphinic acid with a monofunctional, difunctional, polyfunctional and/or heterocyclic epoxy compound.

It is preferable that for the production of these flame retardant mixtures at least one monofunctional epoxy compound from the group of the glycidyl ethers of the polyethylene oxide (IX)

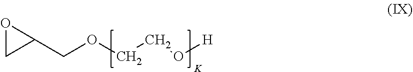

or of the polypropylene oxide (X), (XI)

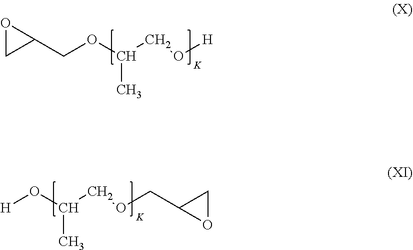

or from the group of the glycidyl compounds of a linear or branched aliphatic monoalcohol having 2 to 8 carbon atoms is used, where K is an integer from 1 to 12.

It is also preferable that for the production of these flame retardant mixtures a difunctional epoxy compound from the group of the diglycidyl ethers of bisphenol A, of bisphenol F and/or of bisphenol A/F of the formula (XII)

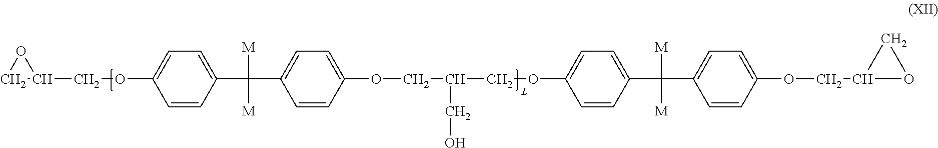

is used, where M is hydrogen and/or methyl and L is an integer from 0 to 5.

The phosphorus-containing flame retardant mixtures can also be characterized in that for the production of these flame retardant mixtures at least one difunctional epoxy compound from the group of the diglycidyl compound of the polypropylene oxide (XIII)

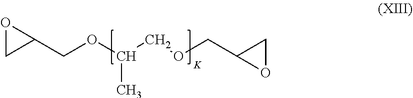

or of the polyethylene oxide (XIV)

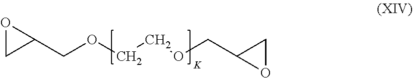

or from the group of the diglycidyl compounds of a linear or branched aliphatic diol having 2 to 8 carbon atoms is used, where K is an integer from 0 to 12.

In another embodiment, for the production of these flame retardant mixtures at least one polyfunctional epoxy compound from the group of the epoxy novolac resins, in particular of the epoxy novolac resins based on phenol and cresol of the formula (XV)

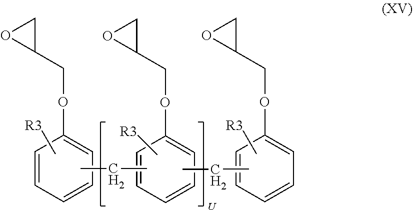

is used, where U is an integer between 1 and 12 and R³ is hydrogen and/or methyl.

In another embodiment, for the production of the flame retardant mixtures at least one heterocyclic epoxy compound from the group of the triglycidyl isocyanurates, N-glycidyl compounds of aromatic amines and of heterocyclic nitrogen bases such as N,N-diglycidylaniline, N,N,O-triglycidyl-p-aminophenol, triglycidyl isocyanurate and N,N,N,N-tetraglycidyl-bis(p-aminophenyl)methane is used.

It is preferable that the phosphorus-containing flame retardant mixtures of the invention are non-halogenated in accordance with the standard IEC 61249-2-21 or are halogen-free.

The invention also provides a process for the production of flame retardant mixtures according to one or more of claims 1 to 20, characterized in that a reaction of at least one phosphinic acid, alkylphosphinic acid and/or dialkylphosphinic acid with the opened ring of an epoxide takes place in the presence of a catalyst.

It is preferable that the catalyst is ethyltriphenylphosphonium chloride, ethyltriphenylphosphonium bromide, ethyltriphenylphosphonium iodide, ethyltriphenylphosphonium acetate, ethyltriphenylphosphonium phosphate, tetrabutylphosphonium chloride, tetrabutylphosphonium bromide, tetrabutylphosphonium iodide, tetrabutylphosphonium acetate, tetrabutylphosphonium acetate acetic acid complex, butyltriphenylphosphonium tetrabromobisphenate, butyltriphenylphosphonium bisphenate, butyltriphenylphosphonium bromide and/or butyltriphenylphosphonium bicarbonate.

It is preferable that in the process of the invention a dialkylphosphinic acid is reacted with an epoxy novolac at 95° C. to 160° C. for 1 to 6 hours.

The invention also provides the use of phosphorus-containing flame retardant mixtures according to one or more of claims 1 to 20 for the production of epoxy resin formulations.

The invention in particular provides flame-retardant epoxy resin formulations comprising at least one phosphorus-containing flame retardant mixture according to one or more of claims 1 to 20, epoxy resins, hardeners, accelerators, rheology additives and/or other additions.

It is preferable that the other additions are light stabilizers, colour pigments, dispersion additives, antifoams, blowing agents, foam-formers, additives for the improvement of mechanical strength, additives for the adjustment of thermal conductivity, glass spheres, glass powders, glass fibre, carbon fibre and/or thixotropizing agents.

The invention also provides a process for the production of the abovementioned epoxy resin formulations, characterized in that the phosphorus-containing flame retardant mixtures according to one or more of claims 1 to 20 are reacted with epoxy resin, hardener, accelerator, rheology additive and optionally other additions.

It is preferable that no solvents are used in the process of the invention.

Finally, the invention also provides the use of these epoxy resin formulations for, or in, flame-retardant composite components, adhesives, pastes, foams, foam compositions, sealing compositions, hotmelt adhesives, fillers, potting compositions, trowelling compositions, finishing mats, coating systems, fibres, prepregs, masking lacquers for soldering, thermally conductive layers, thermally conductive pastes, shock-absorber layers, LEDs, sensors, insulating applications, circuit boards, antennas, and also in coating systems.

It is very particularly preferable that R¹ and R², are, mutually independently, ethyl or propyl.

In the case of the flame retardant mixtures of the formulae R²¹—O-(I), R²¹—O-(II) and/or R²¹—O-(III), the alkyl structures R²¹ preferably have 2 to 8 carbon atoms.

In the case of the compounds of the formula (XII) or (V), L is preferably 0 to 5.

In formula (VI) it is preferable that
U is 1 to 6,
R³ is hydrogen, methyl or ethyl
R⁴ is hydrogen or methyl and
R⁵ is hydrogen or methyl.

According to the invention, the flame retardants having the functional groups (I), (II) and (III) are produced by reaction of at least one phosphinic acid with a monofunctional, difunctional, polyfunctional and/or heterocyclic epoxy compound.

It is therefore possible that various types of flame retardants are present in the flame retardant mixtures of the invention.

For the production of these flame retardant mixtures it is preferable to use epoxy resins which have an epoxy equivalent weight (EEW) below 210 g/mol, among which are preferably oligomer mixtures of diglycidyl ether based on bisphenol A and also novolac resins based on phenol.

If heterocyclic epoxy compounds are used for the production of the flame retardant mixtures of the invention, in such cases triglycidyl isocyanurates are particularly suitable.

The phosphorus-containing flame retardant mixtures of the invention preferable comprise less than 900 ppm of chlorine, less than 900 ppm of bromine and in total less than 1500 ppm of halogens (in the form of halogen-containing substances), and therefore are non-halogenated in accordance with the standard IEC 61249-2-21.

In another preferred embodiment, the phosphorus-containing flame retardant mixtures are halogen-free.

It is preferable that the synthesis of the flame retardant mixtures of the invention is achieved with ring-opening of epoxy groups and with formation of a covalent P—O—C bond via formation of phosphinic ester structures of the type R¹R²P(═O)O—CH₂—CH(OH)—CH₂— and, respectively, of the type R¹R²P(═O)O—CH(CH₂OH)—CH₂—.

It is preferable that the catalyst is ethyltriphenylphosphonium iodide, which is used in quantities below 0.1 percent by weight (%), based on the flame retardant mixture. The resultant total halogen content is below 1500 ppm.

It is preferable that a dialkylphosphinic acid is reacted with an epoxy novolac in the process of the invention at 120° C. to 150° C. for 3 to 6 hours in the presence of the catalyst.

Surprisingly, it has been found according to the present invention that the resultant modified epoxy resins, produced from the phosphinic acids (and, respectively, from the phosphinic acid mixtures) and from the appropriate epoxy resins have a relatively low viscosity and therefore improved processing conditions if a specific isomer ratio of the two resultant esters is successfully established during the synthesis. In particular, the catalyst is responsible for the above.

Two regioisomers or regioisomer mixtures of the modified resins are obtained, these having the distinguishing feature that the resultant P—O—C phosphinic-ester structure can occur either at the CH₂ group or else at the CH group of the oxirane ring. For each oxirane group, however, only reaction with one equivalent of the respective phosphinic acid is possible.

Surprisingly, it has moreover been found that these different (regio)isomers in the modified epoxy resins, and the quantitative proportions that are formed, can be controlled by way of the two moieties R¹ and R² on the phosphinic acid and by way of the catalyst.

The ratio of the regioisomers or mixtures of these in turn has a decisive effect on the viscosity of the resultant phosphorus-modified epoxy resins.

The products according to the invention have a low viscosity and subsequently, in the hardened composite component, lead to good fire behaviour; i.e. the final products are less combustible. They also have good flame retardant properties and high phosphorus content. They moreover comprise no P-dimer by-products, R¹R²P(═O)—O—P(═O)R¹R², which are toxic and exhibit a problematic increased level of migration behaviour.

It is moreover possible in the production process of the invention to control the isomer ratio by means of catalyst, and to achieve targeted adjustment to a low viscosity.

The abovementioned catalysts based on quaternary phosphonium structures have proved to be particularly suitable for the process of the invention.

It is moreover possible, through the selection of a suitable catalyst, to avoid reaction of the epoxy resins with one another, with consumption of epoxy groups. Reaction of the epoxy resins with one another would cause an undesired viscosity increase, and additionally the consumption of the epoxy groups would adversely affect hardening by the hardener (lower glass transition temperatures).

Because of the relatively high viscosity, it would then moreover be necessary to use a solvent during processing, or to operate at relatively high temperature; this would lead to unnecessarily high energy cost.

The catalyst also reduces the proportion of possible by-products that can arise during the reaction with the mono- or disubstituted phosphinic acids. Formation of corresponding dimers is thus reduced or avoided, and the modified epoxy resin therefore has a relatively high phosphorus content together with a low viscosity.

The avoidance of volatile, low-molecular-weight, non-migration-resistant dimeric phosphorus components, which can otherwise arise in such reactions, moreover achieves improved long-term stability and surface quality in the subsequent final thermoset product.

With the process of the invention it is possible to achieve different phosphorus contents in the modified epoxy resins, in that only a certain proportion of the epoxy groups is modified by the phosphinic ester structure, and some of the epoxy groups are not reacted. Depending on the number of remaining epoxy groups it is thus possible to achieve a favourable influence on crosslinking/hardening.

In a downstream hardening step, a hardener can be admixed with the low-viscosity epoxy resins thus modified, in order to obtain thermoset structures which have not only good flame retardancy properties but also high glass transition temperatures.

The familiar hardeners of the type known for epoxy resins can be used here. Curing by isocyanates, via reaction of the primary and secondary OH groups of the two regioisomers of the modified epoxy resin, is also advantageous.

Because of the relatively low viscosity, these components can be manufactured without use of solvents, and there is no need to use relatively high processing temperatures in order to reduce the viscosity. It is thus possible to conserve resources, time and energy in the manufacture of the corresponding products.

The epoxy resins modified according to the invention can be used as sole epoxy resin component or together with other epoxy resins or in a blend with other resins and/or fillers. Among the other resins are preferably phenolic resins, benzoxazines, cyanate esters and polyols of the type used in polyurethane chemistry.

Because of the relatively low viscosity of epoxy resins modified according to the invention, it is also possible to achieve problem-free incorporation of other fillers that in other circumstances are associated with a viscosity increase. The maximal viscosity at which the components can be produced can thus be realized with a higher filler content.

If components with reinforcement fibres are manufactured, better fibre wetting can be realized because of the reduced viscosity. The mechanical properties of the component are thus improved.

The epoxy resins modified according to the invention have particularly good suitability for modern production technologies such as resin transfer moulding (RTM) technology, liquid compression moulding (LCM) technology and other infusion technologies that require low resin-formulation viscosity at processing temperature.

Epoxy resins of the following formula (XVI) are suitable for phosphorus-modification with the mono- and disubstituted phosphinic acids of the type R¹R²P(═O)OH:

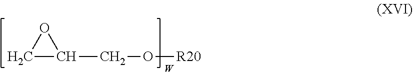

in which R²⁰ is a substituted or unsubstituted aromatic, aliphatic, cycloaliphatic or heterocyclic group and W is 1 to 14.

W is preferably 1 to 6.

The moiety R²⁰ in the formula (XVI) can derive from the following groups: resorcinol, catechol, hydroquinones, bisphenol, bisphenol A, bisphenol bisphenol K, phenol-formaldehyde novolac resin, alkyl-substituted phenol-formaldehyde resins, phenol-hydroxybenzaldehyde resins, cresol-hydroxybenzaldehyde resins, dicyclopentadiene-phenol resins, dicyclopentadiene-substituted phenolic resins, tetramethylbiphenol resins and/or combinations thereof.

Epoxy resins having at least one epoxy structure are particularly suitable for the synthesis of the phosphorus-modified epoxy resin formulations of the invention.

Epoxy resins having a plurality of epoxy structures are also particularly preferable.

Epoxy-novolac resins are particularly suitable, preference here being given to epoxy-novolac resins based on phenol and cresol, and also to epoxidized bisphenol A resins or epoxidized bisphenol F resins.

Examples of possible monofunctional, difunctional or polyfunctional epoxy resins suitable for the production of the phosphorus-containing flame retardants are: diglycidyl ethers of bisphenol A with epoxy equivalent (EEW) between 177 and 189 of the type obtainable by way of example from Dow (Olin) with trade mark DER® 330, and also cycloaliphatic epoxides and copolymers of glycidyl methacrylate ethers and styrene.

Preferred polyepoxides are epoxy novolac resins such as D.E.N.® 438 or D.E.N.® 439 (previously Dow/Olin), cresol epoxy novolac resins, triepoxy compounds such as Tactix® 742, epoxidized bisphenol A novolac resins, dicyclopentadiene-phenol-epoxy-novolac resins; glycidyl ethers of tetraphenolethane; diglycidyl ethers of bisphenol A; diglycidyl ethers of bisphenol F and diglycidyl ethers of hydroquinone.

Aromatic polyglycidyl ethers such as bisphenol A diglycidyl ether, bisphenol F diglycidyl ether and bisphenol S diglycidyl ether, polyglycidyl ethers of phenol/formaldehyde resins and of cresol/formaldehyde resins, resorcinol diglycidyl ether, mono- and diglycidyl ether of polypropylene oxides and of polyethylene oxides, tetrakis(p-glycidylphenyl)ethane, di- and polyglycidyl esters of phthalic, isophthalic and terephthalic acid, and also of trimellitic acid.

It is also possible to use nitrogen-containing epoxy structures which bear one or two epoxy groups on the nitrogen. The starting material here can also comprise multiple occurrences of the nitrogen bearing epoxy groups. The nitrogen itself can also be part of a heterocyclic structure, as is the case for example in triglycidyl isocyanurate.

It is also possible to use hydantoin-epoxy resins and uracil-epoxy resins.

Suitable other epoxy compounds for the production of the phosphorus-containing flame retardant of the invention are tert-butanol glycidyl ether, trimethylolpropane triglycidyl ether, di- and polyglycidyl compounds of polyfunctional aliphatic alcohols such as 1,4-butanediol; oxazolidinone-modified epoxy resins; resins of the bisphenol S type,
for example BPS®-200 from Nippon Kayaku Co., Ltd, EPX®-30 from ACR Co., Epiculon® EXA-1514 from Dainippon Ink & Chemicals Inc; bisphenol A resins such as Epiclon® N-3050, N-7050, N-9050 from Dainippon Ink & Chemicals, XACQ 5005, GT®-7004, 6484T, 6099 from Huntsman; bisphenol F resins such as YDF®-2004, YDF®2007 from Tohto Kasei Co., heterocyclic epoxy resins such as TEPIC® from Nissan Chemical Industries, Ltd., Araldite® PT 810 from Huntsman, epoxidized novolacs such as EPPN®-201, EOCN®-103, EOCN®-1020, EOCN®-1025 produced by Nippon Kayaku Co., Ltd, ECN® 278, ECN®-292 and ECN® 299 from Asahi Chemical Industry Co., Ltd., GY®-1180, ECN®-1273 and ECN®-1299 from CIBA GEIGY AG, YDCN®-220L, YDCN®-220HH, YDCN®-702, YDCN-704, YDPN-601 and YPDN-602 from Tohto Kasei Co., Epiclon® 673, N®-680, N®-695, N®-770 and N®-775 produced by Dainippon Ink & Chemicals Inc.,
amino-functional epoxy resins such as YH®-1402 and ST®-110 from Tohto Kasei Co., YL®-931 and YL®-933 from Yuka Shell Co., rubber-modified epoxy resins such as Epiclon® TSR-601 from Dainippon Ink & Chemicals Inc., EPX®-84-2 and EPX®4061, naphthalene-containing epoxy structures such as those from Dainippon Ink & Chemicals Inc. Epiclon® HP-4710, HP-7250 and HP-9500, silicone-modified epoxy resins such as 1359 from Asahi Denka Kogyo K.K. and other epoxy resins.

The corresponding epoxy equivalent weight (EEW) of these phosphorus-modified resins or resin blends can be up to 8000 g/mol. Structures having good suitability are those with an EEW of 200 g/mol to 4000 g/mol, and preferably those with an EEW of 480 to 3500 g/mol.

Suitable compounds for the production of the phosphorus-modified epoxy resins of the invention are in particular bisphenol, bisphenol A, bisphenol AP, bisphenol B, bisphenol BP, bisphenol C, bisphenol E, bisphenol F, bisphenol FL, bisphenol G, bisphenol M, bisphenol P, bisphenol PH, bisphenol S, bisphenol TMC, bisphenol Z and/or bisphenol K.

Particularly suitable compounds are diglycidyl ethers based on bisphenol A with an epoxy equivalent weight of <210 g/mol (EEW<210 g/mol).

The present invention can use, as catalyst, a large number of acids, amines, imidazoles and quaternary phosphonium salts. Catalysts based on quaternary phosphonium and ammonium compounds are particularly suitable, examples being: ethyltriphenylphosphonium chloride, ethyltriphenylphosphonium bromide, ethyltriphenylphosphonium iodide, ethyltriphenylphosphonium acetate, ethyltriphenylphosphonium phosphate, tetrabutylphosphonium chloride, tetrabutylphosphonium bromide, tetrabutylphosphonium iodide, tetrabutylphosphonium acetate, tetrabutylphosphonium acetate acetic acid complexes, butyltriphenylphosphonium tetrabromobisphenate, butyltriphenylphosphonium bisphenate, butyltriphenylphosphonium bromide, butyltriphenylphosphonium bicarbonate, benzyltrimethylammonium chloride, tetramethylammonium hydroxide, butyltriphenylphosphonium chloride, ethyltriphenylphosphonium acetate, ethyltriphenylphosphonium bromide, ethyltriphenylphosphonium iodide, methyltriphenylphosphonium bromide, tetrabutylammonium bromide, tetrapropylammonium bromide, tetraphenylphosphonium bromide and appropriate mixtures thereof.

The flame retardants produced by the process of the invention have a narrow molecular weight distribution, because the catalyst used suppresses side-reactions and prevents the formation of phosphorus-containing dimers (for example anhydrides).

Other fillers and polymers can be added to the phosphorus-modified epoxy resins in order to optimize the desired properties in the final application. Mention may be made here in particular of epoxy resins, flame retardants and additives for the improvement of mechanical strength (“tougheners”). The latter can be compounds from the group of the thermoplastic polymers, elastomers or a core-shell rubber.

The invention is illustrated by the examples which follow.

TABLE 1
Components used

| Abbreviation | Material | Product name | Producer/Supplier |
|---|---|---|---|
| EPN | Epoxy novolac resin | DEN ® 438 | Olin (Germany) |
| DGEBA | Diglycidyl ether-bisphenol A resin | Beckopox ® EP 140 | Allnex (Germany) |
| TGIC | Triglycidyl isocyanurate | — | Sigma-Aldrich |
| t-BuGE | tert-Butylglycidyl ether | — | Aldrich-Aldrich |
| BuDGE | Butanediol diglycidyl ether | — | Sigma-Aldrich |
| ETPPI | Ethyltriphenylphosphonium iodide | — | Sigma-Aldrich |
| DEPS | Diethylphosphinic acid | — | Clariant |
| DPPS | Diphenylphosphinic acid | — | Clariant |
| EPPS | Ethylphenylphosphinic acid | — | Clariant |
| DICY | Dicyandiamide | Dyhard ® 100S | Alzchem (Germany) |
| TETA | Triethylenetetramine | — | Sigma-Aldrich |
| DOPO resin | DOPO-modified epoxy resin | Struktol ® VP 3735 | Schill-Seilacher |
| | | | (Germany) |

— = no trade name

TABLE 2
Analytical methods

| Parameter | Unit | Process |
|---|---|---|
| Epoxy equivalent (EEW) | g/mol | DIN 16945: 1989-03 |
| Total phosphorus | m % (mass per cent) | ISO 13730 photometry after pulping |
| NMR | ppm | ³¹P-NMR, ¹H-NMR |
| Viscosity | mPas | Rheometer (in-house method) |
| Isomer ratio (I)/(II) | % | ³¹P-NMR, ¹H-NMR (integral) |
| Proportions | in each case mol % | Epoxy equivalent and NMR |
| X of structure (I) | | |
| Y of structure (II) | | |
| Z of structure (III) | | |
| P dimer | yes/no | ³¹P-NMR |

TABLE 3
Abbreviations

Cat1: Ethyltriphenylphosphonium iodide
Cat2: Methyltriphenylphosphonium iodide
P-1: Diethylphosphinic acid
P-2: Methylethylphosphinic acid

Analysis of the (I):(II) isomer ratio is achieved by means of 31P-NMR and 1H-NMR spectroscopy. The epoxy equivalent leads to a conclusion concerning the proportion of remaining epoxy groups. X, Y and Z can be determined by combining the NMR results with the epoxy equivalent.

### Examples 1 to 4: Bifunctional Epoxy Resins

### Example 1

802 g of DGEBA are used as initial charge and heated to 130° C. in a flask apparatus with stirrer, reflux condenser, dropping funnel, thermometer and nitrogen supply. 0.1 m % (mass percent, based on total mass of DEPS and DGEBA) of ETPPI is then added, followed by 258 g of DEPS, whereupon an exothermic reaction is observed. Stirring is then continued for 2 h, and the resultant epoxy resin is discharged in the form of hot liquid.

### Example 2 (Comparative)

The reaction is analogous to that of Example 1, but without ethyltriphenylphosphonium iodide as catalyst.

### Example 3

By analogy with Example 1, 1000 g of DGEBA are used as initial charge and heated to 130° C., then 0.1 m % of ethyltriphenylphosphonium iodide is added, followed by 642 g of diethylphosphinic acid, whereupon an exothermic reaction can be observed. Stirring is then continued for 2 h, and the resultant epoxy resin is discharged in the form of hot liquid.

### Example 4 (Comparative)

The reaction is analogous to that of Example 3, but without ethyltriphenylphosphonium iodide as catalyst.

| | | Example 2 | | Example 4 |
|---|---|---|---|---|
| | Example 1 | (comparative) | Example 3 | (comparative) |
| DGEBA (g) | 802 | 802 | 1000 | 1000 |
| Cat 1 | yes | no | yes | no |
| P1 (g) | 258 | 258 | 642 | 642 |
| m % of P | 6.2 | 6.2 | 9.7 | 9.7 |
| EEW (g/mol) | 482 | 700 | 6000 | 7000 |
| 31P-NMR | 61.1 ppm (I); | 61.3 ppm (I); | 61.1 ppm (I); | 61.3 ppm (I); |
| (DMSO, | 61.7 ppm (II) | 61.8 ppm (II) | 61.7 ppm (II) | 61.8 ppm (II) |
| decoupled) | | | | |
| Viscosity (at | 3450 | 5800 | 16 200 | 16 600 |
| 80° C., 5 s⁻¹) | | | | |
| Isomer ratio I/II | 70/30 | 90/10 | 72/28 | 86/14 |
| (from 31P-NMR) | | | | |
| X | 35 | 59 | 68 | 82 |
| Y | 15 | 7 | 26 | 13 |
| Z | 50 | 34 | 6 | 5 |
| T = Y/(X + Y)*100% | 30% | 10% | 28% | 14% |
| P dimer by-product | no | yes | no | yes |

In each of the Examples 1 and 3, the products of the invention have a higher proportion of isomer II. The higher proportion of II is discernible from the value of T, which provides the ratio of Y to (X+Y). In each case, therefore, the product of the invention has a lower viscosity than the product of the respective comparative example.

In addition, the products of the invention advantageously comprise no phosphorus-containing dimeric by-products whose unfavourable properties such as increased level of migration and toxicity would render the final product useless.

### Examples 5 to 15: Reaction of Polyfunctional Epoxides

### Example 5

1000 g of epoxy novolac (DEN® 438 with an EEW of 180 g/mol) are used as initial charge and heated to 130° C. in a 2000 ml five-necked flask apparatus with stirrer, reflux condenser, dropping funnel, thermometer and nitrogen supply. 0.1 m % of ethyltriphenylphosphonium iodide (based on total mass) is then added, followed by 73 g of diethylphosphinic acid. Stirring is then continued for 120 min, and the epoxy resin produced is discharged in the form of hot liquid.

The method for Examples 6 to 9 is the same as that for Example 5, but in each case the quantities of diethylphosphinic acid used are as shown in Table 2.

### Example 10

The production process is as in Example 8, but with methyltriphenylphosponium iodide as catalyst instead of ethyltriphenylphosphonium iodide.

### Example 11

The production process is as in Example 8, but with 286 g of ethylmethylphosphinic acid instead of diethylphosphinic acid.

### Example 12 (Comparative)

The production process is as in Example 6, but no catalyst was used.

### Example 13 (Comparative)

The production process is as in Example 8, but no catalyst was used.

### Example 14 (Comparative)

The production process is as in Example 9, but no catalyst was used.

TABLE 2
Examples 5 to 11 of the invention and comparative Examples 12 to 15

| | | | | | | | | 12 | 13 | 14 | 15 |
|---|---|---|---|---|---|---|---|---|---|---|---|
| Example | 5 | 6 | 7 | 8 | 9 | 10 | 11 | (comp.) | (comp.) | (comp.) | (comp.) |
| Epoxy novolac (g) | 1000 | 1000 | 1000 | 1000 | 1000 | 1000 | 1000 | 1000 | 1000 | 1000 | 1000 |
| Cat 1 | yes | yes | yes | yes | yes | | yes | no | no | no | no |
| Cat 2 | | | | | | yes | | | | | |
| P-1 (diethyl) | 73 | 155 | 210 | 335 | 568 | 335 | | 155 | 335 | 568 | 0 |
| P-2 (MeEt) | | | | | | | 286 | | | | |
| m % of P | 1.7 | 3.4 | 4.2 | 6.4 | 9.2 | 6.4 | 6.4 | 3.2 | 6.4 | 9.2 | 0 |
| EEW (g/mol) | 225 | 273 | 328 | 496 | 2700 | 491 | 503 | 332 | 605 | about | 181 |
| | | | | | | | | | | 4000 | |
| Viscosity | 11 | 20 | 26 | 36 | 134 | 30 | 39 | 29 | 48 | 165 | 2 |
| (Pas @ 80° C., 5 s⁻¹) | | | | | | | | | | | |
| Isomer ratio I/II | 62/38 | 67/33 | 59/41 | 69/31 | 70/30 | 75/25 | 69/31 | 95/5 | 93/7 | 92/8 | — |
| X | 9 | 16 | 20 | 36 | 61 | 38 | 37 | 36 | 58 | 83 | 0 |
| Y | 5 | 8 | 14 | 16 | 26 | 13 | 17 | 2 | 2 | 8 | 0 |
| Z | 86 | 76 | 66 | 48 | 13 | 49 | 46 | 62 | 4 | 9 | 100 |
| T | 36% | 33% | 41% | 31% | 30% | 25% | 31% | 5% | 3% | 9% | — |
| P dimer | no | no | no | no | no | no | no | yes | yes | yes | no |

The above table reveals, with comparable phosphorus content, that the epoxy resins of Examples 5 to 11 produced according to the invention in each case have a higher proportion of isomer II than the products of the respective comparative Examples 12 to 15.

The products of the invention moreover in each case have a lower viscosity than the product of the respective comparative example with comparable phosphorus content, and therefore the products of the invention provide a simple, or the only, method of achieving solvent-free processing. The products of the invention advantageously comprise no phosphorus-containing dimeric by-products whose unfavourable properties such as increased level of migration and toxicity would render the final product useless.

### Examples 16 to 19 of the Invention

### Example 16 (with Monofunctional Epoxide)

100.0 g of tert-butyl glycidyl ether and 0.1 m % of ethyltriphenylphosphonium iodide (based on total content) are used as initial charge and heated to 120° C. under nitrogen in a reaction flask with stirrer, reflux condenser, dropping funnel and thermometer, and then 91.8 g of diethylphosphinic acid are slowly added dropwise and stirring is continued for 30 minutes. This gives a colourless liquid product.

### Example 17 (with a Trifunctional Heterocyclic and Nitrogen-Containing Epoxide)

100.0 g of triglycidyl isocyanurate (TGIC) are used as initial charge and melted in a glass flask with reflux condenser, thermocouple, nitrogen supply and stirrer. 0.1 m % of ethyltriphenylphosphonium iodide (based on total content) is then added and the mixture is stirred, the temperature in the flask is increased to 130° C., and 41.0 g of diethylphosphinic acid are slowly added, with stirring and under a stream of nitrogen, and the mixture is kept at 130° C. for 30 min. The product is then discharged in the form of a warm liquid, and cooled.

### Example 18 (with a Trifunctional Heterocyclic and Nitrogen-Containing Epoxide)

The procedure is as in Example 17, but 123.0 g of diethylphosphinic acid are reacted (instead of 41.0 g).

### Example 19 (Difunctional Epoxide: Butanediol Diglycidyl Ether)

100.0 g of butanediol diglycidyl ether are used as initial charge in a glass flask with thermometer, nitrogen supply, dropping funnel, condenser and stirrer, and 0.1 m % of ethyltriphenylphosphonium iodide (based on total content) are added, and the mixture is stirred. 120.8 g of diethylphosphinic acid are now added dropwise at a temperature of 130° C. After the reaction has continued for 30 min, the transparent product, which has good flowability, is cooled and discharged.

### Example 20 (Comparative, Difunctional Epoxide: Butanediol Diglycidyl Ether)

100.0 g of butanediol diglycidyl ether are used as initial charge in a glass flask with thermometer, nitrogen supply, dropping funnel, condenser and stirrer, and the mixture is stirred. 120.8 g of diethylphosphinic acid are added dropwise at a temperature of 130° C. After the reaction has continued for 30 min, the product is cooled and discharged.

TABLE 3
Examples 16 to 19 and Example 20 (comparative)

| | | | | | 20 |
|---|---|---|---|---|---|
| Example | 16 | 17 | 18 | 19 | (comp.) |
| tert-Butyl glycidyl | 100 | | | | |
| ether (g) | | | | | |
| TGIC (g) | | 100 | 100 | | |
| Butanediol diglycidyl | | | | 100 | 100 |
| ether (g) | | | | | |
| Cat 1 | yes | yes | yes | yes | no |
| P-1 (diethylphosphinic | 91.8 | 41.0 | 123 | 120.8 | 120.8 |
| acid) (g) | | | | | |
| m % of P | 11.5 | 7.6 | 14 | 13.9 | 13.9 |
| 31P-NMR | 60.7 ppm | 60.9 ppm | 60.9 ppm | 60.9 ppm | 60.9 ppm |
| | (isomer I); | (isomer I); | (isomer I); | (isomer I); | (isomer I); |
| | 60.6 ppm | 61.1 ppm | 61.1 ppm | 61.2 ppm | 61.2 ppm |
| | (isomer II) | (isomer II) | (isomer II) | (isomer II) | (isomer II) |
| EEW (g/mol) | about 2000 | 221 | about 5000 | about 2500 | about 4900 |
| Viscosity (mPas @ | 20 | 11 000 | 7500 | 120 | 255 |
| 80° C., 5 s−1) | | | | | |
| Isomer ratio | 64/36 | 67/33 | 66/34 | 63/37 | 82/18 |
| A/B | | | | | |
| (from 31P-NMR) | | | | | |
| X | 58 | 25 | 61 | 57 | 78 |
| Y | 33 | 12 | 31 | 34 | 17 |
| Z | 9 | 63 | 7 | 9 | 5 |
| T = Y/(X + Y)*100% | 36% | 33% | 34% | 37% | 18% |
| Phosphorus-containing | no | no | no | no | yes |
| dimeric by-product | | | | | |

The examples in the above table reveal in each case for the inventive products 16 to 19 a higher proportion of isomer II than in the product of comparative Example 20.

The inventive product 19 moreover respectively has a lower viscosity than the product of comparative Example 20, thus facilitating solvent-free processing.

1. Phosphorus-containing flame retardant mixtures, comprising individual flame retardants having in each case one or more functional groups of the formulae (I), (II) and (III), 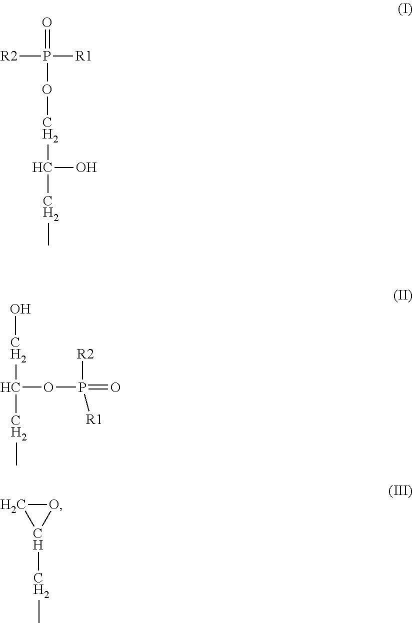
where, based on the total quantity of functional groups in the flame retardant mixture, 1 to 98 mol % of functional groups of the formula (I), 1 to 35 mol % of functional groups of the formula (II) and 1 to 98 mol % of functional groups of the formula (III) are present, and where R¹ and R² are identical or different and are mutually independently hydrogen, C₁- to C₁₂-alkyl, linear or branched, and/or C₆- to C₁₈-aryl and the entirety of (I), (II) and (III) is always 100 mol %,
wherein, in the mixture of the formulae (I) and (II), the proportion T (in mol %) of formula (II) is calculated from T=[y/(x+y)]*100%, where x is the quantity of formula (I) and y is the quantity of formula (II), in each case in mol %, wherein T is 20 to 45 mol %.

2. Phosphorus-containing flame retardant mixtures according to claim 1, wherein R¹ and R² are identical or different and are mutually independently hydrogen, methyl, ethyl, n-propyl, isopropyl, n-butyl, isobutyl, sec-butyl, tert-butyl, n-pentyl, 2-methylbutyl, 3-methylbutyl, 3-methylbut-2-yl, 2-methylbut-2-yl, 2,2-dimethylpropyl, hexyl, heptyl, octyl, nonyl, decyl, cyclopentyl, cyclopentylethyl, cyclohexyl, cyclohexylethyl and/or phenyl.

3. Phosphorus-containing flame retardant mixtures according to claim 1, wherein R¹ and R² are identical or different and are mutually independently methyl, ethyl, n-propyl, isopropyl, n-butyl, isobutyl, sec-butyl and/or tert-butyl.

4. Phosphorus-containing flame retardant mixtures according to claim 1, wherein they comprise
5 to 94 mol % of formula (I),
3 to 35 mol % of formula (II) and
3 to 92 mol % of formula (III), where the entirety of (I), (II) and (III) is always 100 mol %.

5. Phosphorus-containing flame retardant mixtures according to claim 1, wherein they comprise
25 to 90 mol % of formula (I),
5 to 30 mol % of formula (II) and
5 to 70 mol % of formula (III), where the entirety of (I), (II) and (III) is always 100 mol %.

6. (canceled)

7. (canceled)

8. (canceled)

9. Phosphorus-containing flame retardant mixtures according to claim 1, wherein the individual flame retardants having the functional groups (I), (II) and (III) in the flame retardant mixtures correspond to the formulae R²¹—O-(I), R²¹—O-(II) and/or
R²¹—O-(III), where R²¹ means linear or branched alkyl structures having 2 to 8 carbon atoms and/or means polypropylene oxides of the type —[—CH(CH₃)—CH₂—O—]ₖ—H or —[—CH₂—CH(CH₃)—O—]ₖ—H and/or means polyethylene oxides of the type —[—CH₂—CH₂—O—]ₖ—H, where k is in each case an integer from 1 to 12.

10. Phosphorus-containing flame retardant mixtures according to claim 1, wherein the individual flame retardants having the functional groups (I), (II) and (III) in the flame retardant mixtures correspond to the formula D-O—[—CH₂—CH₂—O-]ᵣ-E and/or
D-O—[—CH(CH₃)—CH₂—O-]ᵣ-E, where D and E can be identical or different and in each case represent the formula (I), (II) and/or (III), and r is an integer from 1 to 12.

11. Phosphorus-containing flame retardant mixtures according to claim 1, wherein the individual flame retardants having the functional groups (I), (II) and (III) in the flame retardant mixtures correspond to the formula (IV)
E-Q-D (IV),
where Q represents the following formula (V) 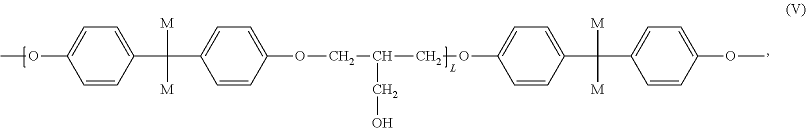
in which M is hydrogen or methyl and where D and E can be identical or different and in each case represent the formulae (I), (II) and/or (III) and L is an integer from 0 to 5.

12. Phosphorus-containing flame retardant mixtures according to claim 1, wherein the individual flame retardants having the functional groups (I), (II) and (III) in the flame retardant mixtures correspond to the formula (VI) 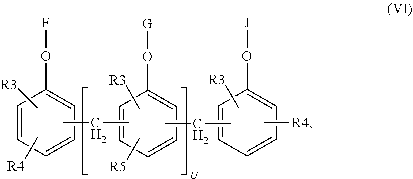
where F, G and J can be identical or different and in each case represent the formulae (I), (II) and/or (III), U is an integer between 1 and 12, R³ is hydrogen, methyl, ethyl, propyl and/or butyl, and R⁴ and R⁵ are mutually independently hydrogen, methyl and/or 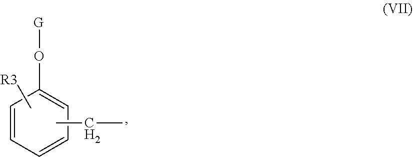
where G and R³ are defined as above.

13. Phosphorus-containing flame retardant mixtures according to claim 1, wherein the individual flame retardants having the functional groups (I), (II) and (III) in the flame retardant mixtures correspond to the formula (VIII) 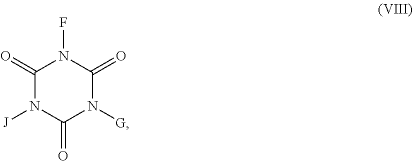
where F, G and J can be identical or different and in each case represent the formulae (I), (II) and/or (III).

14. (canceled)

15. (canceled)

16. (canceled)

17. (canceled)

18. (canceled)

19. (canceled)

20. Phosphorus-containing flame retardant mixtures according to claim 1, wherein they are non-halogenated in accordance with the standard IEC 61249-2-21 or are halogen-free.

21. Process for the production of flame retardant mixtures according to claim 1, wherein a reaction of at least one phosphinic acid, alkylphosphinic acid and/or dialkylphosphinic acid with the opened ring of an epoxide takes place in the presence of a catalyst,
characterized in that the catalyst is ethyltriphenylphosphonium chloride, ethyltriphenylphosphonium bromide, ethyltriphenylphosphonium iodide, ethyltriphenylphosphonium acetate, ethyltriphenylphosphonium phosphate, tetrabutylphosphonium chloride, tetrabutylphosphonium bromide, tetrabutylphosphonium iodide, tetrabutylphosphonium acetate, tetrabutylphosphonium acetate acetic acid complex, butyltriphenylphosphonium tetrabromobisphenate, butyltriphenylphosphonium bisphenate, butyltriphenylphosphonium bromide and/or butyltriphenylphosphonium bicarbonate.

22. (canceled)

23. Process according to claim 21, wherein a dialkylphosphinic acid is reacted with an epoxy novolac at 95° C. to 160° C. for 1 to 6 hours.

24. Process according to claim 21, wherein the flame retardant mixtures comprise at least one phosphinic ester structure of the formula R¹R²P(═O)O— and the synthesis proceeds by way of a P—O—C bond at the opened epoxide ring, where R¹ and R² are defined as in claim 1.

25. Use of phosphorus-containing flame retardant mixtures according to claim 1 for the production of epoxy resin formulations.

26. Flame-retardant epoxy resin formulation, comprising at least one phosphorus-containing flame retardant mixture according to claim 1, epoxy resins, hardeners, accelerators, rheology additives and/or other additions.

27. Flame-retardant epoxy resin formulation according to claim 26, wherein the other additions are light stabilizers, colour pigments, dispersion additives, antifoams, blowing agents, foam-formers, additives for the improvement of mechanical strength, additives for the adjustment of thermal conductivity, glass spheres, glass powders, glass fibre, carbon fibre and/or thixotropizing agents.

28. Process for the production of epoxy resin formulations, comprising:
reacting the phosphorus-containing flame retardant mixtures according to claim 1 with epoxy resin, hardener, accelerator, rheology additive and optionally other additions.

29. Process according to claim 28, wherein no solvents are used.

30. Use of epoxy resin formulations according to claim 26 for, or in, flame-retardant composite components, adhesives, pastes, foams, foam compositions, sealing compositions, hotmelt adhesives, fillers, potting compositions, trowelling compositions, finishing mats, coating systems, fibres, prepregs, masking lacquers for soldering, thermally conductive layers, thermally conductive pastes, shock-absorber layers, LEDs, sensors, insulating applications, circuit boards, antennas, and also in coating systems.
